(19) United States
(12) Patent Application Publication
(10) Pub. No.: US 2025/0070831 A1
(43) Pub. Date: Feb. 27, 2025

(54) NETWORK CONFIGURATION USING COUPLED OSCILLATORS

(71) Applicant: General Electric Company, Schenectady, NY (US)

(72) Inventor: Stephen F. BUSH, Schenectady, NY (US)

(21) Appl. No.: 18/722,125

(22) PCT Filed: Dec. 20, 2022
(86) PCT No.: PCT/US2022/082025

§ 371 Date: Jun. 20, 2024

Related U.S. Application Data
(60) Provisional application No. 63/291,500, filed on Dec. 20, 2021.
(60) Provisional application No. 63/292,228, filed on Dec. 21, 2021.

(51) Int. Cl. H04B 7/0456; H04B 7/0417; H04L 5/00

(52) U.S. Cl. CPC H04B 7/0456; H04B 7/0417; H04L 5/0048; H04L 5/006

(57) ABSTRACT

A radio network (e.g., a multiple-input multiple-output (MIMO) radio network) includes a transmitter node and a receiver node. The transmitter node is configured to determine whether a radio link (e.g., a MIMO link) associated with a plurality of subchannels is carrying time sensitive networking (TSN) traffic. In accordance with a determination that the radio link is carrying TSN traffic, the transmitter node is configured to obtain configuration values (e.g., a plurality of channel path coefficients) based on estimated quality of each of the plurality of subchannels; adjust the configuration values such that variance in quality of the plurality of subchannels is minimized; and transmit data to the receiver node via the plurality of subchannels in accordance with the adjusted configuration values.

### CROSS-REFERENCE TO RELATED APPLICATIONS

This application claims the benefit of priority to U.S. Provisional Patent Application Ser. No. 63/291,500, filed Dec. 20, 2021 and U.S. Provisional Patent Application Ser. No. 63/292,228, filed Dec. 21, 2021, which are incorporated herein by reference in their entirety.

### TECHNICAL FIELD

This disclosure relates to techniques for optimizing transmission of time-sensitive (deterministic) traffic over wireless communication networks.

### BACKGROUND

Radio networks (for example, 5G) are wireless and therefore subject to variable channel conditions. For best-effort traffic transported using a multiple-input multiple-output (MIMO) radio link using multiple transmission and receiving antennas to exploit multipath propagation, networks may adapt to variable channel conditions and optimize for throughput or quality. However, for deterministic traffic such as time-sensitive networking (TSN) traffic, such optimizations do not account for variances in latency introduced by the variable channel conditions inherent in wireless networks. Such variations in latency make it impossible to schedule truly deterministic TSN traffic over radio networks.

### SUMMARY

This disclosure describes implementations of a radio network, including the radio access network (RAN), that optimize for both best-effort traffic and deterministic, scheduled traffic. If a node on the network determines that data to be transmitted is TSN data, the node optimizes the communication link to maintain constant latency during the transmission.

Specifically, a wireless communication system including a radio network with a transmitter node and a receiver node is provided. The transmitter node may be configured to determine whether a radio link associated with a plurality of subchannels is carrying time sensitive networking (TSN) traffic. In accordance with a determination that the radio link is carrying TSN traffic, the transmitter node may obtain configuration values based on estimated quality of each of the plurality of subchannels, adjust the configuration values such that variance in quality of the plurality of subchannels is minimized, and transmit data to the receiver node via the plurality of subchannels in accordance with the adjusted configuration values.

In some implementations, a wireless communication system comprises a multiple-input multiple-output (MIMO) radio access network including a transmitter node and a receiver node. The transmitter node is configured to determine whether a MIMO link associated with a plurality of subchannels is carrying TSN traffic. In accordance with a determination that the MIMO link is carrying TSN traffic, the transmitter node is configured to obtain a plurality of channel path coefficients based on estimated quality of each of the plurality of subchannels; adjust the plurality of channel path coefficients such that variance in quality over time of the plurality of subchannels is minimized; and transmit data to the receiver node via the plurality of subchannels in accordance with the adjusted channel path coefficients.

In some implementations, the receiver node is configured to estimate quality of each of the plurality of subchannels by determining a signal strength perceived by each of the plurality of subchannels; and transmit, to the transmitter node, the plurality of channel path coefficients based on the signal strength perceived by each of the plurality of subchannels.

In some implementations, the receiver node is configured to determine the signal strength perceived by each of the plurality of subchannels associated with the MIMO link based on a pilot signal received from the transmitter node via the plurality of subchannels.

In some implementations, the channel path coefficients are weights in a channel information matrix.

In some implementations, the transmitter node is configured to adjust the plurality of channel path coefficients by: determining a plurality of weights for each of the plurality of channel path coefficients that would minimize variance in latency over time with respect to each of the plurality of subchannels; and applying respective weights of the plurality of weights to respective channel path coefficients of the plurality of channel path coefficients.

In some implementations, the transmitter node is configured to adjust the plurality of channel path coefficients by: determining a plurality of weights for each of the plurality of channel path coefficients that would minimize variance in bit error rate with respect to each of the plurality of subchannels; and applying respective weights of the plurality of weights to respective channel path coefficients of the plurality of channel path coefficients.

In some implementations, the transmitter node is further configured to: maintain a history of quality estimates of each of the plurality of subchannels over time; and adjust the plurality of channel path coefficients based on the history of quality estimates of each of the plurality of subchannels over time.

In some implementations, the estimated quality of each of the plurality of subchannels is based on a measured latency with respect to each of the plurality of subchannels.

In some implementations, the estimated quality of each of the plurality of subchannels is based on a measured bit error rate with respect to each of the plurality of channels.

In some implementations, the transmitter node includes a plurality of antennas respectively corresponding to the plurality of subchannels; and each channel path coefficient of the plurality of channel path coefficients respectively corresponds to an antenna of the plurality of antennas.

In some implementations, the transmitter node is configured to determine whether the MIMO link is carrying TSN traffic by determining that data received at the MIMO link represents TSN configuration data.

In some implementations, the TSN configuration data includes one or more of: TSN administration cycle time; TSN maximum latency for each flow over the MIMO link; TSN gate control list information for each flow entering the MIMO link; and/or TSN frame replication data describing member streams over the MIMO link.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of a radio access network 100 in accordance with some implementations.

FIG. 2 is a block diagram of pilot transmission 202 and data transmission 204 phases of a radio access network in accordance with some implementations.

FIG. 3 is a block diagram of a channel information matrix 302 of a radio access network 300 in accordance with some implementations.

FIG. 4 is a block diagram 400 depicting usage of a channel information matrix in accordance with some implementations.

FIG. 5 is a flow diagram 500 depicting fading in wireless communications in accordance with some implementations.

FIG. 6 includes block diagrams depicting a channel model 602 and spatial multiplexing 605 in wireless communications in accordance with some implementations.

FIG. 7 includes block diagrams depicting channel reciprocity principle 702 and feedback from the receiver 704 in accordance with some implementations.

FIG. 8 is a flow diagram of a method 800 of operating a radio access network in accordance with some implementations.

FIG. 9 is a block diagram depicting information 902, 904, and 906 shared between TSN and MIMO in accordance with some implementations.

FIG. 10 is a graph depicting an example target bit error rate in accordance with some implementations.

FIG. 11 is a block diagram illustrating an integrated TSN-5G system rate in accordance with some implementations.

### DETAILED DESCRIPTION

5G radio access networks are wireless and have variable message latency (packet delay), which makes truly deterministic TSN scheduling difficult. Current MIMO systems adapt to channel conditions to maximize throughput rather than maintain constant throughput. One solution is to enable the RAN exhibit constant latency over varying channel conditions. This solution uses both historical and current channel estimation information to set the channel information matrix in such a manner that the latency over the channel remains constant over time. This requires modification of the way the channel information matrix is configured for a given channel state. Stated another way, this disclosure describes techniques for supporting the transmission of TSN traffic over a radio access network by dynamically adjusting the channel information matrix in order to meet a constant target latency. Instead of minimizing noise, maximizing throughput, or maximizing spatial reuse, the goal is to maintain a constant (or close to constant) quality of the channel over time. Note that this constant channel quality condition may be applied only to the channels carrying TSN traffic.

Another solution may involve use of a buffer, gates, and overprovisioning the channel at a higher layer (e.g., the transport layer). While this alternative solution may give the illusion of constant throughput, this would require additional memory (traffic buffers) and hardware, which would increase cost and reduce reliability. Therefore, this disclosure focuses on more efficient solutions at the physical layer, related to adjusting the channel information matrix to minimize variance in channel latency (packet delay).

Stated another way, rather than optimizing antenna capabilities to gain maximum diversity or maximum capacity, this disclosure focuses on maximizing stability (by minimizing the variation of capacity), which is important for deterministic networking and TSN. Determinism in TSN requires maintaining a constant latency (or close to constant latency) over a channel over time. This requires modifying the way channel information is estimated, as described in more detail below.

In some implementations, the performance goals of a MIMO system can be specified to include, but not be limited to, a user-defined combination of: (a) maximizing availability (b) minimizing error rate (c) maximizing spatial reuse (d) maximizing overall capacity and (e) minimizing variance in latency over time (for a time-sensitive (TSN) MIMO system), among many other key performance indicators. The performance goal can be a weighted combination of these goals, where the weighting can vary to match traffic requirements. For example, a TSN flow may place most or all weight upon minimizing variance in the MIMO system. The weighting described here can be exposed via standard network management protocols or change per message, based upon tags within each message.

There are multiple ways to maintain stability in terms of latency and capacity.

In some implementations, a transmitter in a radio access network may use historical information about the variation in latency (for actual transmissions and/or the pilot data sent over a MIMO network), which involves constantly measuring signal strength from antennas over time, providing a historical view of channel estimates over time.

In other implementations, a transmitter in a radio access network may determine a target latency and use a combination of channels or subchannels (antenna beamforms) but vary (i) the number of channels and (ii) which channels are used, to maintain constant latency.

Importantly, there may be more traffic than just TSN traffic at the transmitter. There may be TSN (scheduled) traffic and (best-effort) traffic, all sharing the same link. In conventional radio access networks, MIMO and the physical layer (PHY) are decoupled from the higher layers. The radio access networks described in this disclosure, however, couple MIMO and TSN. Specifically, for a set of antennas at the transmitter, the transmitter may understand the antennas are carrying specific TSN traffic flows. These flows can be allocated to different combinations of antenna elements, to both maintain latency and understand reliability of that link.

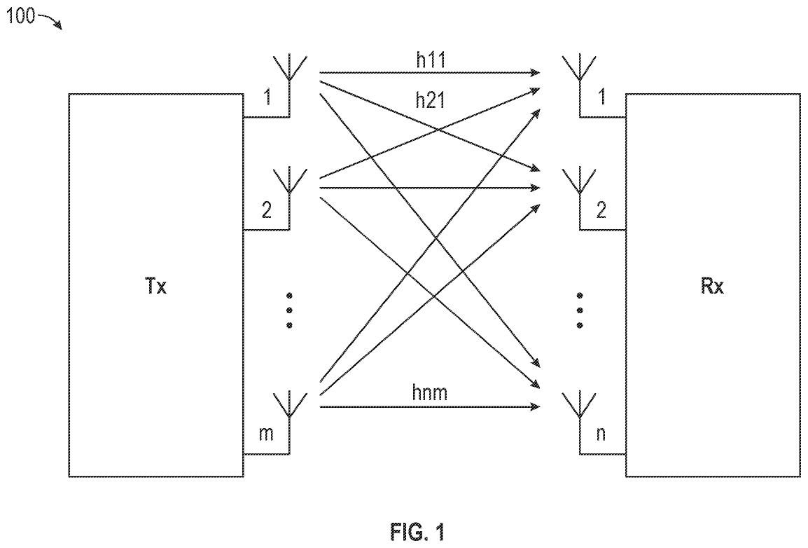

FIG. 1 is a block diagram of a MIMO radio access network 100 in accordance with some implementations. MIMO is a radio communications technology or radio frequency (RF) technology. Wi-Fi, Long-Term Evolution (LTE) technology, fifth generation (5G) wireless technology, and many other radio, wireless, and RF technologies may use MIMO wireless technology to provide increased link capacity and spectral efficiency combined with improved link reliability using what were previously seen as interference.

MIMO networks use multiple antennas at the transmitter (1 through m) and receiver (1 through n) to enable a variety of signal paths (channels comprising a set of antenna beamforms) to carry data, choosing separate paths for each antenna to enable multiple signal paths to be used. The signal can take many paths between a transmitter and a receiver. The variety of paths available occurs as a result of the number of objects that are located between the transmitter and receiver. These additional paths can be used to provide additional robustness to the radio link by improving the signal to noise ratio, or by increasing the link data capacity.

One MIMO format focuses on spatial diversity. Spatial diversity often refers to transmit and receive diversity. Another format focuses on spatial multiplexing, which is used to provide additional data capacity by utilizing the different paths to carry additional traffic, i.e., increasing the data throughput capability. These methodologies are used to provide improvements in the signal-to-noise ratio and they are characterized by improving the reliability of the system with respect to the various forms of fading. By increasing the number of transmit antennas (m) and receive antennas (n), it is possible to linearly increase the throughput of the channel with every pair of antennas added to the system.

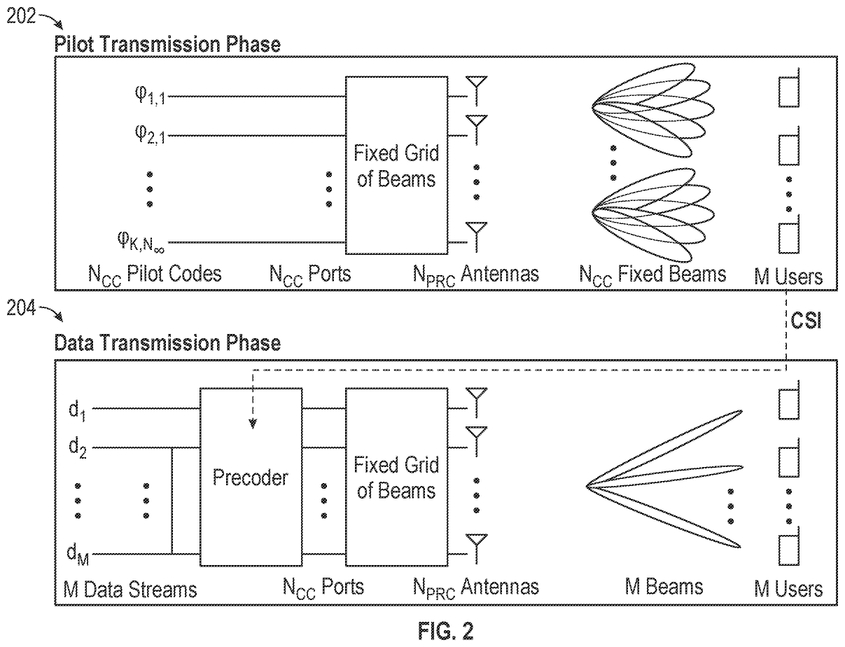

FIG. 2 includes block diagrams of a pilot transmission phase 202 and a data transmission phase 204 of a radio access network in accordance with some implementations. A radio access network may perform channel state estimation for deterministic 5G MIMO and TSN using the pilot transmission phase.

In the pilot transmission phase, transmitter antennas send pilot signals (known training sequences) to receiver antennas, and the receive estimates channel quality (e.g., by estimating signal strength) of the respective channels based on the quality of the received pilot signals. The receiver sends these quality estimates via Channel State Information (CSI) to a precoder of the transmitter, and the transmitter uses these quality estimates to adjust subsequent data transmissions by adjusting the channel information matrix as described in more detail below.

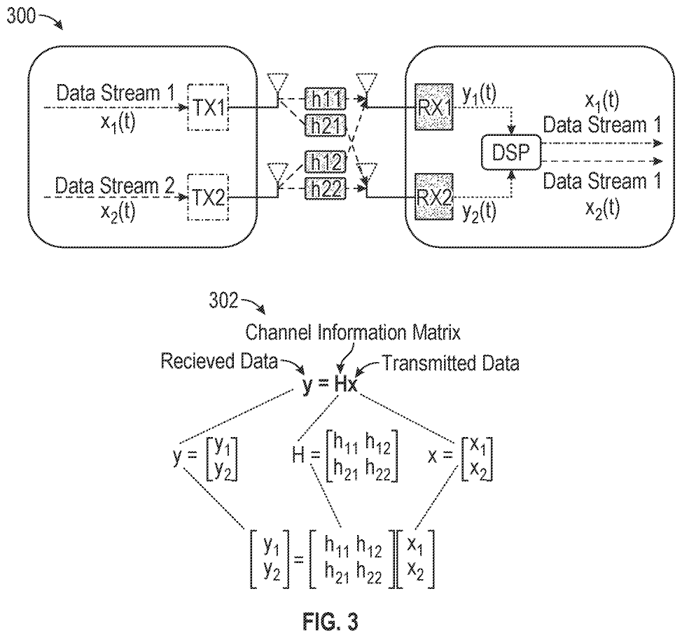

FIG. 3 is a block diagram of a channel information matrix 302 of a radio access network 300 in accordance with some implementations. To take advantage of the additional throughput offered, MIMO wireless systems utilize a matrix mathematical approach. Data streams x1, x2, . . . xn can be transmitted from antennas 1, 2, . . . n. There are a variety of paths that can be used with each path having different channel properties. To enable the receiver to be able to differentiate between the different data streams it is necessary to use weighted coefficients in a channel information matrix. These can be represented by, for example, h12 (travelling from transmit antenna 1 to receive antenna 2) and so forth.

The receiver feeds back the coefficients for the channel information matrix to the transmitter, and the transmitter performs precoding (adjusting the weights of the channel information matrix). The channel information matrix determines which antenna beams get weighted more (have more weight in recomposing the signal at the receiver). More weight is given to channels that are performing better or otherwise preferred. In the presently described implementations, the weights are allocated to keep latency constant (rather than maximizing diversity or capacity).

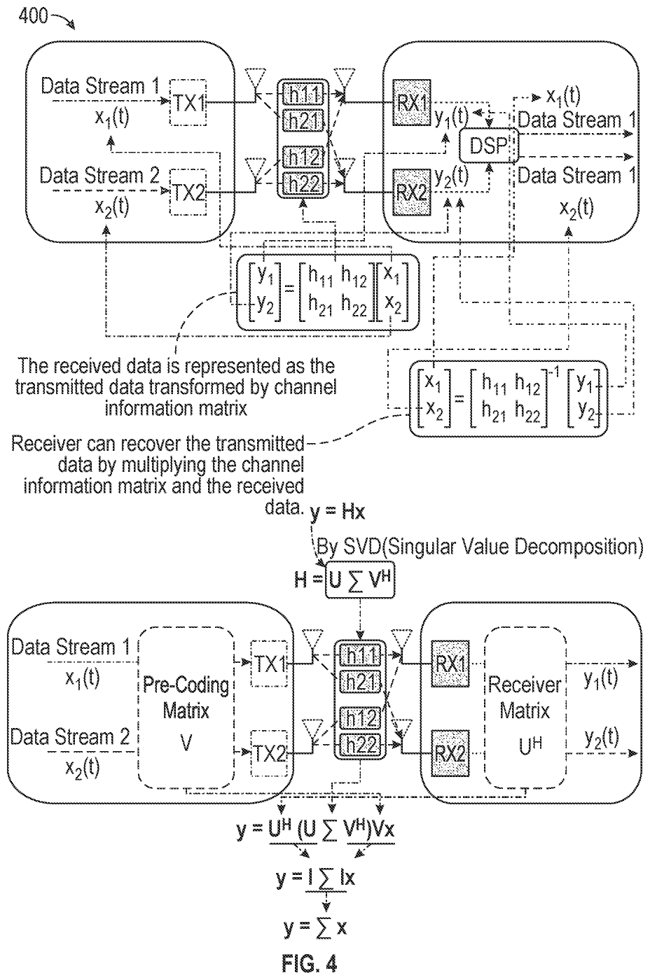

FIG. 4 is a block diagram 400 depicting usage of a channel information matrix in accordance with some implementations. Using a matrix of antenna weights, the coefficients may be applied to a vector of a given antenna, and a vector of output strengths may be obtained. A singular value decomposition (SVD) operation may be performed to obtain the output strengths. The channel coefficients are h. In sum, the channel information matrix can be used to recover the signal.

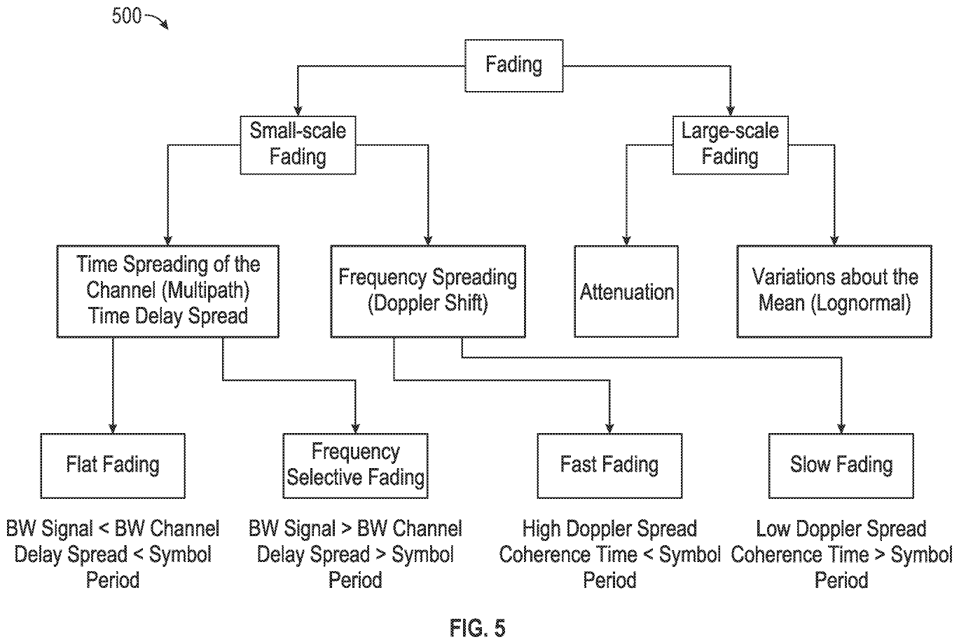

FIG. 5 is a flow diagram 500 depicting fading in wireless communications in accordance with some implementations. Fading is variation of the attenuation of a signal with various variables. These variables include time, geographical position, and radio frequency. Fading is often modeled as a random process. A fading channel is a communication channel that experiences fading. Fading is an issue that causes the variations in latency that hurt TSN flows. Such variations may be stabilized by adjusting the weights of the channel matrix to minimize latency variance as described herein.

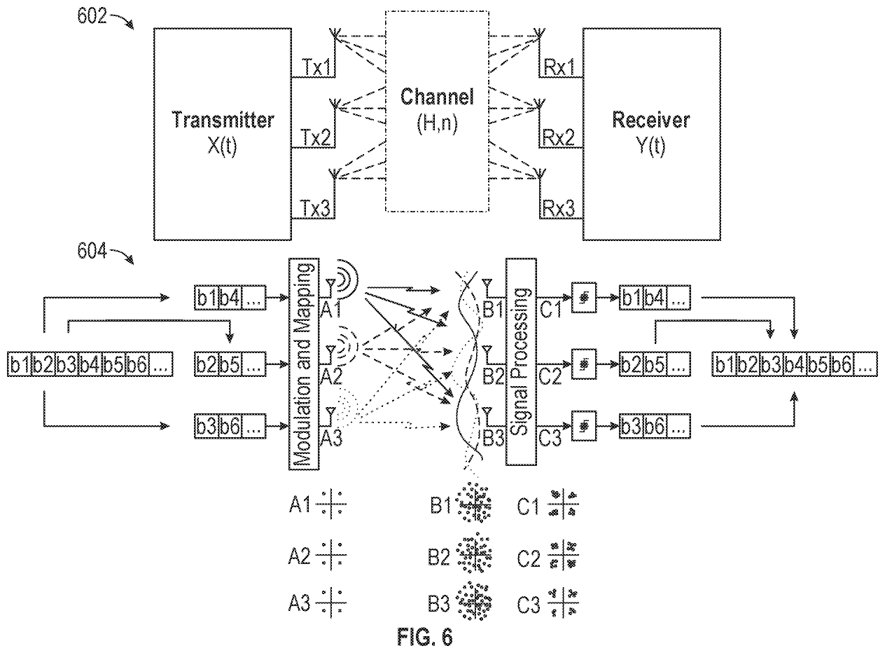

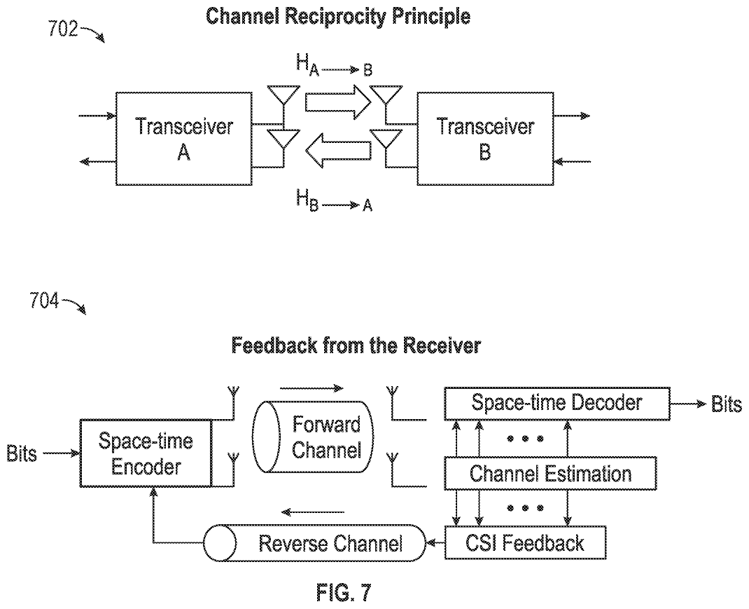

FIG. 6 includes block diagrams depicting a channel model 602 and spatial multiplexing 605 in wireless communications in accordance with some implementations, and FIG. 7 includes block diagrams depicting channel reciprocity principle 702 and feedback from the receiver 704 (i.e., how the transmitter obtains channel quality estimates) in accordance with some implementations.

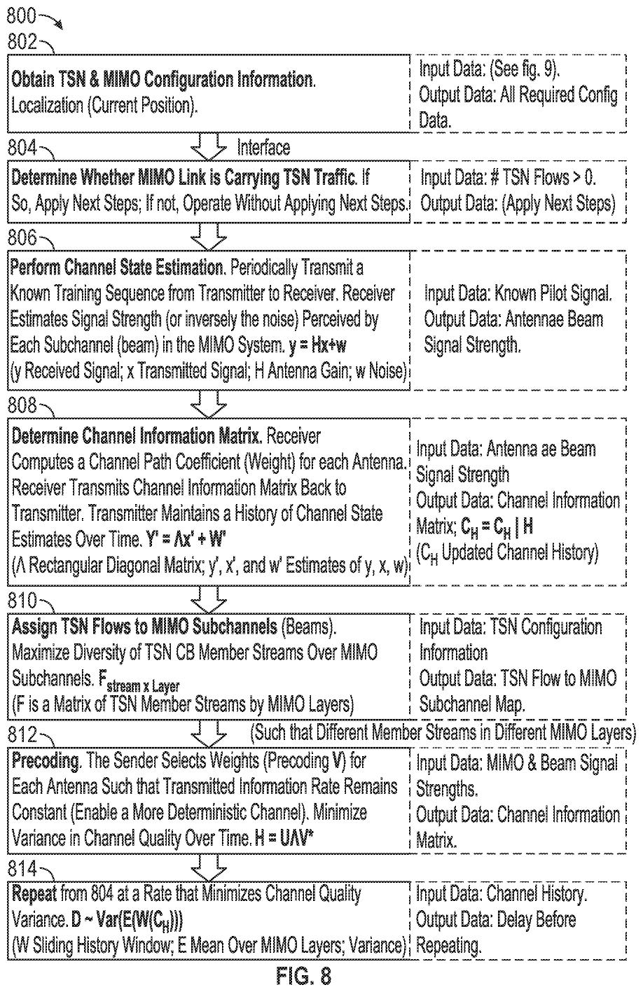

FIG. 8 is a flow diagram of a method 800 of operating a radio access network in accordance with some implementations. The process may be governed by instructions that are stored in a memory or non-transitory computer readable storage medium in a transmitter node and/or in a receiver node of a radio access network. The instructions may be included in one or more programs stored in the non-transitory computer readable storage medium. When executed by one or more processors, the instructions cause the transmitter and/or receiver to perform the process. The non-transitory computer readable storage medium may include one or more solid state storage devices, magnetic or optical disk storage devices, or other non-volatile memory devices. The instructions may include source code, assembly language code, object code, or any other instruction format that can be interpreted by one or more processors. Some operations in the process may be combined, and the order of some operations may be changed.

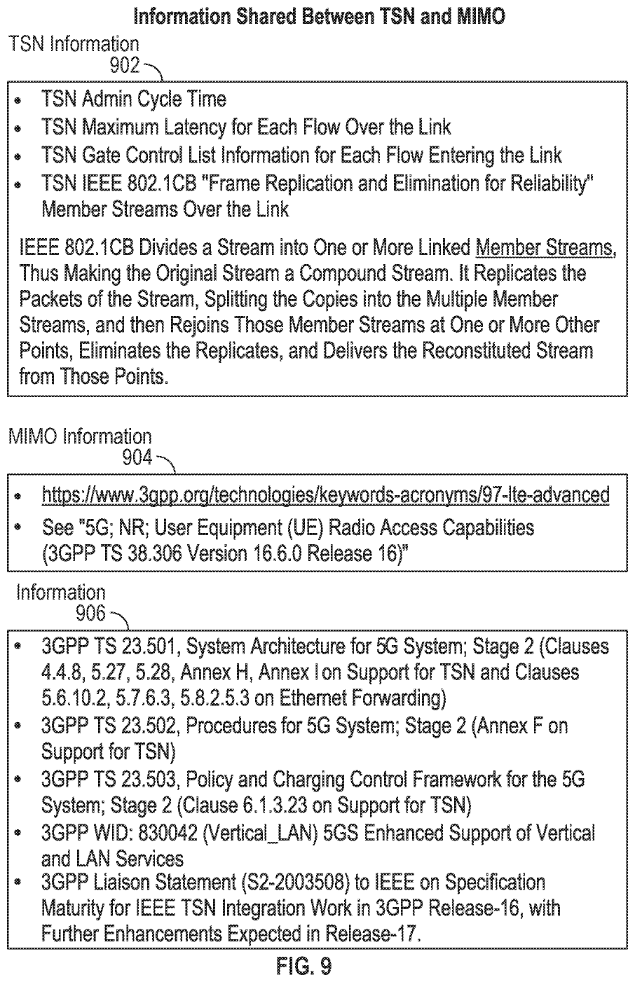

The transmitter obtains (802) TSN and MIMO configuration information. Example information is included in FIG. 9.

For example, TSN information 902 may be shared with the transmitter, including one or more of TSN admin cycle time, TSN maximum latency for each flow over the link, TSN gate control list information for each flow entering the link, and/or TSN IEEE 802.1CB “Frame Replication and Elimination for Reliability” member streams over the link. IEEE 802.1CB divides a Stream into one or more linked Member Streams, thus making the original Stream a Compound Stream. It replicates the packets of the Stream, splitting the copies into the multiple Member Streams, and then rejoins those Member Streams at one or more other points, eliminates the replicates, and delivers the reconstituted Stream from those points. In other words, 802.1CB is the standard for TSN multiple parallel paths over the same channel (the standard for multiple parallel TSN flows). In some implementations, TSN shares with the transmitter (i) a maximum latency specification, and (ii) a specification that 802.1CB is being used for reliability. As such, the transmitter uses MIMO to place the flows over the proper channels accordingly, so that antennae transmissions do not overlap among different flows.

As another example, MIMO information 904 may be shared with the transmitter, including one or more of:
3GPP TS 38.306 version 16.6.0 Release 16,
3GPP TS 23.501, System Architecture for 5G System; Stage 2 (clauses 4.4.8, 5.27, 5.28, Annex H, Annex I on support for TSN and clauses 5.6.10.2, 5.7.6.3, 5.8.2.5.3 on Ethernet forwarding)
3GPP TS 23.502, Procedures for 5G System; Stage 2 (Annex F on support for TSN)
3GPP TS 23.503, Policy and Charging Control Framework for the 5G System; Stage 2 (clause 6.1.3.23 on support for TSN)
3GPP WID: 830042 (Vertical LAN) 5GS Enhanced support of Vertical and LAN Services; and/or
3GPP Liaison Statement (S2-2003508) to IEEE on specification maturity for IEEE TSN integration work in 3GPP Release-16, with further enhancements expected in Release-17.

Based on the configuration information, the transmitter determines (804) whether the MIMO link is carrying TSN traffic. If so, the method proceeds with operations 806 through 814. If not, the method does not proceed with operations 806 through 814.

The transmitter performs (806) channel state estimation. In some implementations (for example, as discussed above with respect to FIG. 2), the transmitter periodically transmits a known training or pilot sequence from transmitter antennas to receiver antennas in the MIMO system, and the receiver estimates signal strength (or inversely the noise) perceived by each antenna in the MIMO system.

The receiver determines (808) a channel information matrix. In some implementations, the receiver computes a channel path coefficient (weight h) for each antenna. The receiver transmits the channel information matrix back to transmitter, and the transmitter maintains a history of channel state estimates over time. In some implementations, instead of or in addition to computing a channel path coefficient, the receiver determines one or more channel characteristics based on the received pilot sequences. For example, the receiver may determine channel characteristics such as a bit error rate, latency values, signal to noise ratio values, etc. for the received pilot sequences, and provide the channel characteristic values to the transmitter. The transmitter may store the channel characteristic values, e.g., along with the channel state estimates, and use such stored values for precoding.

The transmitter performs (812) precoding. In some implementations, precoding includes determining or otherwise adjusting weights h for each antenna such that the transmitted information rate and therefore latency remains constant, enabling a more deterministic channel, which is ideal for TSN traffic. In other words, rather than optimizing for maximum throughput or maximizing diversity, this method minimizes variance in latency over time. In some implementations, bit error rate can be derived from signal strength or directly measured.

In some implementations, the transmitter adjusts the weights to maintain stable latency. Additionally, or alternatively, the transmitter may adjust the rate at which these operations occur, to also attempt to maintain stable latency. In a highly varying channel situation, the transmitter may perform these operations more quickly in order to minimize variance in latency, and vice versa.

In some implementations, the transmitter performs operation 812 (adjusts the weights) to directly maintain a constant latency, or to directly maintain a constant bit-error rate (which may be used as a proxy for setting latency).

The transmitter repeats (814) the operations from operation 804, thereby transmitting subsequent data using the adjusted channel information matrix.

Thus, operations 804-814 in method 800 are specific for TSN traffic only. Further, these operations maintain a constant quality, latency, and/or bit-error rate (rather than minimizing these measures) at the physical layer.

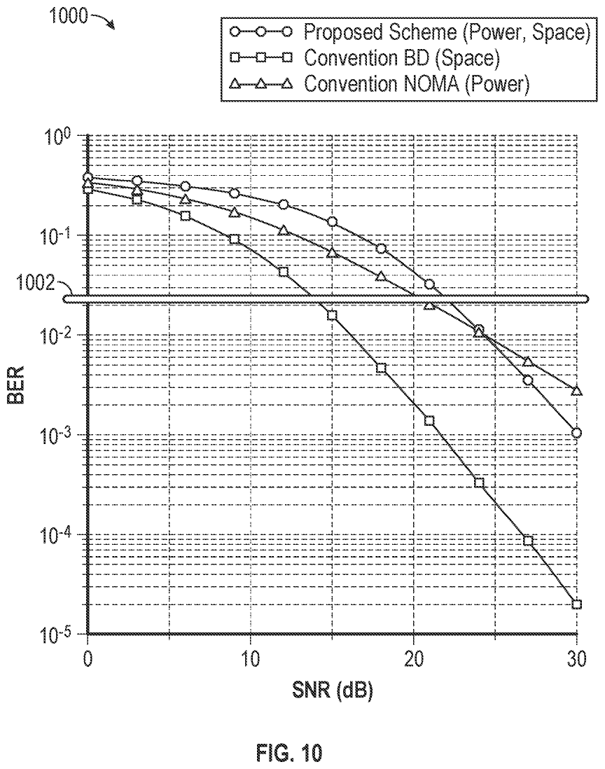

FIG. 10 is a graph depicting an example target bit error rate in accordance with some implementations. Rather than maximizing channel capacity (throughput) or channel diversity (reliability), the goal in the present disclosure is to minimize channel variation (jitter), by utilizing MIMO PHY to help maintain a constant TSN flow rate (otherwise, sudden variations in channel quality result in message loss and/or time-varying recovery mechanisms). Time-sensitive flows can be scheduled over suitable MIMO channel antenna combinations, and IEEE 802.1CB TSN reliability can also be scheduled with knowledge of MIMO antenna combinations.

These concepts are depicted in FIG. 10. Instead of a downward slope, the bit-error rate may be kept constant (or close to constant) at, for example, value 1002, rather than decreasing below line 1002 over higher signal-to-noise ratio (SNR) (which is what convention radio access networks do, when maximizing bit-error rate at every point of the curve).

The description above covers techniques for minimizing the variance in latency over time over a radio access network. That is, latency over the network is kept as constant as possible over time. Rather than minimizing variance in latency over certain channels during a snapshot in time, variance in latency is minimized over time, so that latency variations continually decrease until the latency is constant (or close to constant). In some implementations, network characteristics (e.g., channel information matrix variables) are determined in order to both (i) minimize variations in latency so that such variations are below a threshold, and (ii) keep variations in latency below the threshold once the threshold has been reached. Alternatively, rather than keeping latency variations below a thresholds, latency variations are minimized as much as possible.

The following discussion includes alternative implementations for minimizing the variance in latency over time over a radio access network. In these implementations, network parameters may be adjusted in addition to, or as an alternative to, the channel information matrix adjustments described above in order to minimize variation in network latency. As described above, by minimizing variations in latency, determinism is increased, thereby optimizing network communications for scheduled traffic.

In some implementations, one or more frequencies and/or time slots at which packets are transmitted through the network may be adjusted in order to minimize network latency. For example, if a particular frequency slot or a particular time slot is associated with noise (e.g., an amount of noise above a threshold), a scheduler associated with a transmitter may cause the transmitter to switch to a different frequency slot or a different time slot in order to maintain a constant latency. If a history of frequency slots and/or time slots and corresponding noise information is maintained, the scheduler may use such a history to continue switching or otherwise adjusting frequency slots and/or time slots in order to minimize variations in latency.

In some implementations, a resource block and/or element (i.e., incorporating 5G scheduling with MIMO and TSN) may make such frequency and/or time slot adjustments. In other words, a 5G scheduler may work in concert with MIMO to minimize variations in latency.

In some implementations, 5G New Radio (NR) modulation and coding schemes (MCS) used to transmit data over the MIMO network may be adapted to minimize network latency. The MCS may define the numbers of useful bits per symbols. In some implementations, MCS selection or adaptation is done based on radio channel conditions and block error rate (BLER). In a 5G network, for example, MCS may be changed by gNodeB (gNB) based on the link adaptation algorithm, and the updated or changed MCS information is provided to the user equipment (UE). 5G NR supports QPSK, 16 QAM, 64 QAM and 256 QAM modulation as part of MCS. There are at least 32 MCS Indexes (0-31) currently defined and MCS Index 29, 30, and 31 are reserved and used for re-transmission.

In some implementations, IEEE 802.1CB reliability may be used as a factor in MIMO antenna mapping to minimize variations in latency. As discussed above, according to 802.1CB reliability techniques, TSN flows are implemented over different MIMO subchannels (flows). A mapping may be determined between the TSN flows and the MIMO subchannels that minimizes overlaps so a fault in one MIMO subchannel does not interrupt multiple TSN flows. Stated another way, a radio access network may be configured to support multiple physical flows (antenna beams) with MIMO flows, with TSN flows running on top of the MIMO flows. It is desirable to avoid implementing a plurality of TSN flows for 802.1CB traffic on the same physical MIMO subchannel, because if that subchannel gets interrupted (e.g., knocked out due to noise, etc.), then both the main path and the redundant path will be knocked out. As such, it is desirable to diversify redundant TSN streams on different MIMO subchannels.

Accordingly, in some implementations in which the data transmitted by the transmitter node to the receiver node may include redundant (same) data corresponding to or carried over in at least two TSN flows. In such implementations, the transmitter node is configured to transmit the data to the receiver node such that the redundant data corresponding to the at least two TSN flows are transmitted via separate subchannels of the plurality of subchannels. Accordingly, the redundant data is not communicated on the same subchannel such the all the redundant data is lost if that subchannel is noisy or experiencing other interferences.

In some implementations, transmission antenna power levels may be adjusted to minimize variations in latency.

In some implementations, a priori channel sounding may be used to minimize variations in latency. A priori channel sounding uses radio frequency (RF) levels of a physical space in which network components are located in order to understand how the physical space would affect such components. For example, a priori channel sounding of a particular room may be performed, and a model of the room may be determined based on the a priori channel sounding. Based on the model, the MIMO system may be adjusted to minimize variations in latency. Specifically, the information from the model may take the form of a statistical characterization inside the MIMO system. By keeping a channel history that the system can use (giving it knowledge ahead of time of what the room looks like), the system can maintain constant latency (or near constant latency with minimum variation) in terms of noise and/or interference.

In some implementations, the radio access network may remain below a link budget to allow for mitigation of noise in order to minimize variations in latency. Specifically, in radio systems that estimate power loss and create link budgets, it may be desirable for such systems to operate slightly beneath the link budget (e.g., below a predetermined threshold). A link budget may be described in terms of signal-to-noise ratio (SNR) or power levels. As such, a radio system may operate below a maximum SNR or power level (rated for a given network or transmission scenario), thus giving some breathing room in case of unexpected noise in order to minimize variations in latency.

In some implementations, any of the techniques described herein for minimizing variations in latency may be applied to communication systems using a single antenna. In other words, such techniques are not limited to MIMO systems.

In some implementations, a radio access network may predict noise variation based on position and historical information in order to minimize variations in latency. Such techniques are related to channel sounding of a room. If the communication system associates a particular location or position in the physical space with a particular amount of noise (e.g., over a threshold), the system may take that into account when minimizing variation. Specifically, location information and associated noise characteristics may be used as inputs for making adjustments to minimize variations in latency. For example, if a transmitter sends a pilot signal and receives feedback from a receiver, the location of the transmitter and/or the location of the receiver may be taken into account in making adjustments (e.g., adjusting coefficients in the channel information matrix) to minimize variations in latency. In some implementations, a pilot signal would not be necessary to make such adjustments; instead, adjustments may be made based on the location of the transmitter and/or the location of the receiver combined with historical noise data associated with the location(s).

Accordingly, in some implementations, the transmitter node is configured to adjust the plurality of channel path coefficients based on one or more predefined location or position-based characteristics of the communication system (known via a priori channel sounding).

In some implementations, any of the techniques described herein for minimizing variations in quality or latency may be applied to communication systems based on an alternate form of MIMO called cooperative multiple-input multiple-output (cooperative MIMO), also known as network MIMO, distributed MIMO, virtual MIMO, and virtual antenna arrays. A cooperative MIMO system encompasses a coordinated multipoint (CoMP). Conventional MIMO systems, e.g., as described above (and also known as point-to-point MIMO or collocated MIMO), require both the transmitter and receiver of a communication link to be equipped with multiple antennas. However, such transmitter and receiver devices may have a form factor that is too small to house the required set of antenna, and the separation between antennae on mobile or fixed devices may be insufficient to allow meaningful performance gains. Furthermore, as the number of antennas is increased, performance of a conventional MIMO system falls behind theoretical gains (e.g., due to channel hardening).

In contrast to conventional MIMO, cooperative MIMO uses distributed antennas on different radio devices to improve MIMO performance. For example, using cooperative MIMO, multiple spatially separated devices may be grouped into a virtual antenna array to achieve MIMO communication. A cooperative MIMO transmission involves multiple point-to-point radio links, including links within a virtual array and possibly links between different virtual arrays. More specifically, in CoMP, spatially-separated 5G devices can share their Channel State Information (CSI) and use the shared knowledge to coordinate their transmissions in the downlink and jointly process the received signals in the uplink (e.g., ETSI TS 136 300 V16.6.0 (2021-09) Section 5.2.8 incorporated herein by reference). In some implementations, CoMP may utilize the one or more techniques described in the disclosure to maximize determinism and minimize variation in message delay or latency for TSN traffic transported over spatially-separated and distributed sets of transmission and receive antennas. In some implementations, in order to minimize variation in transmission latency of TSN traffic, the set of spatially-separated transmit and receive antennae may dynamically change. TSN may also be used as a real-time management and control network to enable fast and efficient CoMP operation across a distributed set of antennae.

In some implementations, data describing 5G intelligent reflective surfaces may be used in order to minimize variations in latency. Specifically, since passive or active intelligent surface may reflect radio signals, knowledge of which surfaces exhibit reflective properties may be used to minimize variations in latency.

In some implementations, TSN flow data (i.e., TSN-based MAC and Radio Link Control) may be used to control the antennas of a radio access network. The radio and the user equipment (UE) may have their own 5G protocol layer (i.e., the radio link control layer) to control the radio. TSN flow data can be used as a control mechanism between the radio access network and the UE, so that real-time remote control may be established between the radio access network and the UE. In other words, the radio control layer between the transmitter and the receiver sets up and guides the MIMO beams, and is itself a TSN layer. In some implementations, the link controller may be implemented over a lower quality channel (one that's omnidirectional and not MIMO), which means it could suffer from noise and not as high quality as the MIMO channel that is being set up. As such, once the MIMO channel is set up, then the MIMO channel may support higher quality TSN flows.

In some implementations, beam pointing and/or navigation (e.g., use of optics and/or other advanced techniques for beam pointing) may be used in order to minimize variations in latency. Specifically, the transmitter points the beam at the right spot, so the transmitter antenna array is forming a beam that points to and hits the receiving antenna. Since the transmitter beam and/or the receiver may be moving with respect to one another, there may be a reflective surface between them, and the transmitter may operate as if the beam is pointing to the receiver when it is really not. As such, beam pointing techniques may be employed (e.g., optical, infrared, ultraviolet, or other spectrum) that might be used in conjunction with the radio frequency to help guide the formation of MIMO beams. In other words, instead of or in addition to manipulating the channel information matrix, beam pointing and/or forming may be adjusted in order to minimize variations in latency.

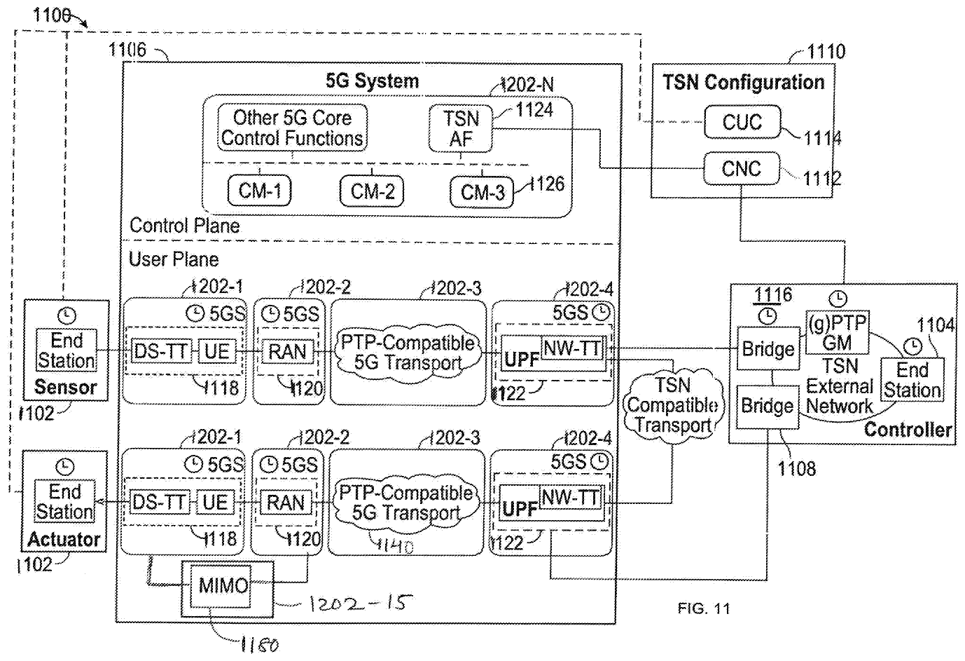

Referring to FIG. 11, which illustrates a non-limiting example of an integrated TSN-5G system 1100 in which each of various components of a 5G network or system 1106 is configured to be emulated as a single TSN component (e.g., a TSN bridge). Overall, the system 1100 is configured as a deterministic TSN system to communicate data between end-devices, e.g., input/output (I/O) devices 1102 and a controller 1104, via the 5G system 1106 (emulating as a network of TSN bridge) and one or more (conventional) TSN bridges 1108 and using a TSN controller 1110. The system 1100 is configured based on standard methods for time synchronization and traffic management, allowing deterministic communication over standard Ethernet networks between end-devices, e.g., the I/O devices 1102 and the controller 1104. For example, the system 1100 may operate in accordance with the IEEE 802.1Q TSN specification suite, which standardizes layer-2 communication for networking protocols providing deterministic communication while sharing the same infrastructure. For example, a number of standards establish various technological paradigms for a TSN system—clock synchronization (802.1AS, generalized Precision Time Protocol (gPTP)), frame preemption (802.3br and 802.1Qbu), scheduled traffic (802.1Qbv), and redundancy management (Frame Replication and Elimination for Reliability (FRER) IEEE 802.1CB). These standards work together at the Ethernet layer-2 to ensure that control and safety functions are executed while meeting their respective deadlines and constraints. As another implementation, similar integrated system may be configured to implement TSN techniques over a wireless local area network (wireless LAN) such as a Wi-Fi network, e.g., based on Wi-Fi 6 and other common wireless LANs.

For example, the 802.1Qbv TSN standard provides scheduled transmissions for safety-critical data frames in a predetermined manner, and is incorporated herein in its entirety. As used herein, “TSN schema” can refer, without limitation, to networks, components, elements, units, nodes, hubs, switches, controls, modules, pathways, data, data frames, traffic, protocols, operations, transmissions, and combinations thereof, that adhere to, are configured for, or are compliant with, one or more of IEEE 802.1 TSN standards. The 802.1Qbv TSN standard addresses the transmission of critical and non-critical data traffic within a TSN. Critical data traffic is guaranteed for delivery at a scheduled time while non-critical data traffic is usually given lower priority. Various traffic classes have been established according to IEEE 802.1Q that are used to prioritize different types of data traffic.

Ethernet frame preemption is defined by the IEEE 802.3br and IEEE 802.1Qbu standards, which can suspend the transmission of a non-critical Ethernet frame, is also beneficial to decrease latency and latency variation of critical traffic. Resource management basics are defined by the TSN configuration models (IEEE 802.1Qcc). Centralized Network Configuration (CNC) 1112 can be applied to the network devices (bridges, e.g., TSN bridges within the 5G system 1106, bridges 1108), whereas, Centralized User Configuration (CUC) 1114 can be applied to user devices (end stations, e.g., the I/O devices 1102), e.g., as specified in IEEE 802.1Qdj [xx]. The fully centralized configuration model follows a software-defined networking (SDN) approach. In other words, the CNC 1112 and the CUC 1114 in the controller 1110 provide the control plane instead of distributed protocols. In contrast, distributed control protocols are applied in the fully distributed model, where there may be no CNC or CUC.

High availability, as a result of ultra-reliability, may be provided by Frame Replication and Elimination for Reliability (FRER) (IEEE 802.1CB) for data flows through a per-packet-level reliability mechanism. This provides reliability by transmitting multiple copies of the same data packets over disjoint paths in the network. Per-Stream Filtering and Policing (802.1Qci) improves reliability by protecting against bandwidth violation, malfunctioning and malicious behavior. Further, the time synchronization in the TSN system may be defined by the generalized Precision Time Protocol (gPTP) (802.1AS), which is a profile of the Precision Time Protocol standard (IEEE 1588). The gPTP provides reliable time synchronization, which can be used by other TSN tools, such as Scheduled Traffic (802.1Qbv).

To achieve desired levels of reliability, TSNs employ time synchronization, and time-aware data traffic shaping. The data traffic shaping uses the schedule to control gating of transmissions on the network switches and bridges (e.g., nodes). In some aspects, the schedules for such data traffic in TSNs can be determined prior to operation of the network. In other aspects, the schedules for data traffic can be determined during an initial design phase based on system requirements, and updated as desired. For example, in addition to defining a TSN topology (including communication paths, bandwidth reservations, and various other parameters), a networkwide synchronized time for data transmission can be predefined. Such a plan for data transmission on communication paths of the network is typically referred to as a “communication schedule” or simply “schedule.” The schedule for data traffic on a TSN can be determined for a specific data packet over a specific path, at a specific time, for a specific duration. A non-limiting example of a technique for generating schedule for TSN data traffic is are discussed in U.S. application Ser. No. 17/100,356, which is incorporated herein in its entirety by reference.

Time-critical communication between end devices or nodes (e.g., the I/O devices 1102 and the controller 1104) in TSNs includes “TSN flows” also known as “data flows” or simply, “flows.” For example, data flows can comprise datagrams, such as data packets or data frames. Each data flow is unidirectional, going from a first originating or source end device (e.g., the I/O device 1102) to a second destination end device (e.g., the controller 1104) in a system, having a unique identification and time requirement. These source devices and destination devices are commonly referred to as “talkers” and “listeners.” Specifically, the “talkers” and “listeners” are the sources and destinations, respectively, of the data flows, and each data flow is uniquely identified by the end devices operating in the system. It will be understood that for a given network topology comprising a plurality of interconnected devices, a set of data flows between the inter-connected devices or nodes can be defined. For example, the set of data flows can be between the interconnected devices. For the set of data flows, various subsets or permutations of the dataflows can additionally be defined. Further, time-critical communication between end devices or nodes in TSNs includes “TSN streams” or “streams,” where each TSN stream may originate at a specific talker node intended to be communicated to one or more listener nodes. As such, each TSN stream may include one or more data flows, where each data flow is between the talker node (where the TSN stream originated) and a listener node.

Both end devices (e.g., 1102, 1104) and switches (commonly called “bridges” or “switching nodes”) transmit and receive the data (in one non-limiting example, Ethernet frames) in a data flow based on a predetermined time schedule. The switching nodes and end devices must be time-synchronized to ensure the predetermined time schedule for the data flow is followed correctly throughout the network. For example, in FIG. 1, the clocks 1116 represent that the various switching nodes and end devices in the TSN system 100 (including in the 5G system 106) are be time-synchronized with reference to a global clock (grandmaster clock timing). In some other aspects, only the switches can transmit the data based on the pre-determined schedule, while the end devices, for example legacy devices, can transmit data in an unscheduled manner.

The data flows within a TSN can be scheduled using a single device (e.g., the controller 1110) that assumes fixed, non-changing paths through the network between the talker/listener devices and switching nodes in the network. Alternatively, the data flows can be scheduled using a set of devices or modules. The scheduling devices, whether a single device or a set of devices, can be arranged to define a centralized scheduler. In still other aspects, the scheduler devices can comprise a distributed arrangement. The TSN can also receive non-time sensitive communications, such as rate-constrained communications. In one non-limiting example, the scheduling devices can include an offline scheduling system or module.

TSN traffic may be tagged using a variety of mechanisms, including VLAN tag Ethernet address IP header information, and a combination of VLAN tag Ethernet address and IP header information. Traffic may be identified and tagged anywhere in the system before protocol data unit (PDU) identification is required. A TSN Talker may create multiple TSN flows (streams) with different TSN latency and determinism requirements and may be assigned different paths that meet the requirements. In some implementations of the subject invention, the latency and determinism values may be specified and offered to TSN applications as a limited set of static, discrete values, rather than an offering to accept an unlimited set of continuous values.

In some implementations, the I/O end device 1102 may be, in various aspects, a complex mechanical entity such as the production line of a factory, a gas-fired electrical generating plant, avionics data bus on an aircraft, a jet engine on an aircraft amongst a fleet (e.g., two or more aircraft), a digital backbone in an aircraft, an avionics system, mission or flight network, a wind farm, a locomotive, etc. In various implementations, the I/O end device 1102 may include any number of end devices, such as mobile cellular devices, sensors, actuators, motors, and software applications. The sensors may include any conventional sensor or transducer, such as a camera that generates video or image data, an x-ray detector, an acoustic pick-up device, a tachometer, a global positioning system receiver, a wireless device that transmits a wireless signal and detects reflections of the wireless signal in order to generate image data, or another device.

Further, the actuators (e.g., devices, equipment, or machinery that move to perform one or more operations of the I/O device 1102) can communicate using the TSN system. Non-limiting examples of the actuators may include brakes, throttles, robotic devices, medical imaging devices, lights, turbines, etc. The actuators can communicate status data of the actuators to one or more other devices (e.g., other I/O devices 1102, the controller 1104 via the TSN system). The status data may represent a position, state, health, or the like, of the actuator sending the status data.

In some implementations, the controller 1104 can communicate a variety of data between or among the I/O end devices 1102 via the TSN 1100. For example, the control system 1104 can communicate the command data to one or more of the devices 1102 or receive data, such as status data or sensor data, from one or more of the devices 1102. Accordingly, the controller 1104 may be configured to control operations of the I/O devices 1102 based on data obtained or generated by, or communicated among the I/O devices 1102 to allow for, e.g., automated control of the I/O devices 1102 and provide information to operators or users of the I/O devices 1102. The controller 1104 may define or determine the data flows and data flow characteristics in the TSN system 1100.

Referring now to the 5G system 1106 within the system 1100, the 5G network or system 1106 is a wireless communication network or system used to carry TSN traffic between various TSN end devices, e.g., the I/O devices 1102 and the controller 1104. In some implementations, the 5G system 1106 is configured to emulate as one or more TSN bridges per User Plane Function (UPF) (similar to TSN bridges 1108, according to the TSN standards discussed above). The 5G system 1106 may be a New Radio (NR) network implemented in accordance with 3GPP 23 and 38 series specifications (which are incorporated herein in their entirety), and integrated into the system 1100 in accordance with the 3GPP Release 17 23.501 standard (for example, v17.1.1 and v17.2.0), which is incorporated herein in entirety. As shown, the 5G system 1106 may include various network components such as, in the 5G user plane, User Equipment (UE) 1118, RAN (gNB) 1120, a MIMO link 1180 between UE 1118 and RAN 1120, User Plane Function (UPF) 1122, and in the 5G control plane, application function (AF) 1124, and session management function (SMF) and policy control function (PCF) 1126, among other components, as defined in the 3GPP 23.501 standard. In some implementations, the 5G system 1106 may be configured to provide an ultra-reliable low latency communication (URLLC) service. The 5G system 1106 based on the New Radio (NR) interface includes several functionalities to achieve low latency for selected data flows. NR enables shorter slots in a radio subframe, which benefits low-latency applications. NR also introduces mini-slots, where prioritized transmissions can be started without waiting for slot boundaries, further reducing latency. As part of giving priority and faster radio access to URLLC traffic, NR introduces preemption—where URLLC data transmission can preempt ongoing non-URLLC transmissions. Additionally, NR applies very fast processing, enabling retransmissions even within short latency bounds.

In some implementations, 5G defines extra-robust transmission modes for increased reliability for both data and control radio channels. Reliability is further improved by various techniques, such as multi-antenna transmission based on MIMO techniques, the use of multiple carriers and packet duplication over independent radio links.

Time synchronization is embedded into the 5G cellular radio systems as an essential part of their operation, which has already been common practice for earlier cellular network generations. The radio network components themselves are also time synchronized, for instance, through the precision time protocol telecom profile, e.g., based on a 5G internal system clock. This provides a good basis to provide synchronization for time-critical applications. For URLLC service, the 5G system 1106 uses time synchronization for its own operations, as well as the multiple antennas and radio channels that provide reliability. Besides the 5G RAN features, the 5G system 1106 may also provide solutions in the core network (CN) for Ethernet networking and URLLC. The 5G CN supports native Ethernet protocol data unit (PDU) sessions. 5G assists the establishment of redundant user plane paths through the 5GS, including RAN, the CN and the transport network. The 5GS also allows for a redundant user plane separately between the RAN and CN nodes, as well as between the UE and the RAN nodes.

The 5G system 1106 includes TSN Translator (TT) functionality for the adaptation of the 5G system 1106 to the TSN domain, both for the user plane and the control plane, hiding the 5G system 1106's internal procedures from the TSN bridged network. The 5G system 1106 provides TSN bridge ingress and egress port operations through the TT functionality. For instance, the TTs support hold and forward functionality for de-jittering.

For the 5G system 1106 to be integrated into the TSN system 1100, requirements of a TSN stream can be fulfilled only when resource management allocates the network resources for each hop along the whole path. In line with TSN configuration (802.1Qcc), this is achieved through interactions between the 5G system 1106 and a configuration controller, e.g., a centralized configuration controller 1110 (including the CUC 1114 and the CNC 1112) and/or a set of decentralized controller modules. The interface between the 5G system 1106 and the CNC allows for the CNC 1112 to learn the characteristics of the 5G virtual bridge, and for the 5G system 1106 to establish connections with specific parameters based on the information received from the CNC 1112. Bounded latency requires deterministic delay from 5G as well as QoS alignment between the TSN and 5G domains. For instance, if a 5G virtual bridge acts as a TSN bridge, then the 5G system 1106 emulates time-controlled packet transmission in line with Scheduled Traffic per 802.1Qbv for example. For the 5G control plane, the TT in the AF 1124 receives the transmission time information of the TSN traffic classes from the CNC 1112. In the 5G user plane, the TT at the UE 1118 and the TT at the UPF 1122 may regulate the time-based packet transmission accordingly. The different TSN traffic classes may be mapped to different 5G QoS Indicators (5QIs) in the AF 1124 and the PCF 1126 as part of the QoS alignment between the TSN and 5G domains, and the different 5QIs are treated according to their QoS requirements.

With respect to time synchronization, the 5G system 1106 may implement the gPTP of the connected TSN network. The 5G system 1106 may act as a virtual gPTP time-aware system and support the forwarding of gPTP time synchronization information between end stations 1102 and bridges 1108 through the 5G user plane TTs. All of the various 3GPP and TSN standards mentioned in this disclosure are incorporated herein by reference in their entireties.

In some implementations, in the disaggregated TSN-5G structure, each of the plurality of components of the 5G system, e.g., the 5G network or system 106 are configured as an individual TSN block 1202 of a plurality of TSN blocks 1202-1 to 1202-N. For example, as shown, the UE 1118 may be configured to emulate as the TSN block 1202-1, the RAN 1120 may be configured to emulate as the TSN block 1202-2, the MIMO link 1180 may be configured to emulate as the TSN block 1202-15, the 5G transport network link 1140 between the RAN 120 and the UPF 122 may be configured to emulate as the TSN block 1202-3, the UPF 1122 may be configured to emulate as the TSN block 1202-4, and the core network and/or other typical components of a 5G system (e.g., fronthaul, backhaul, Multi-access Edge Computing (MEC) module) may be configured to emulate as one or more TSN blocks 1202-N. Each TSN block 1202-1 to 1202-N is configured in accordance with TSN specifications (e.g., per IEEE 802.1 and related standards discussed above), e.g., as a TSN bridge, TSN end device (TSN Talker and/or TSN Listener), or a combination of two.

In some implementations, the TSN block 1202-15 (for the MIMO link 1180) obtains one or more of the following information from TSN configuration controller 1110 (e.g., from the CUC 1114 and/or the CNC 1112):
TSN admin cycle time;
TSN maximum requested latency for each flow over the link;
TSN gate control list information for each flow entering the link;
TSN IEEE 802.1CB “Frame Replication and Elimination for Reliability” parameters and member streams over the link; and
TSN time synchronization resolution (smallest time units recorded in timestamps), stability (ability for time increment without drifting), accuracy (ability to reconstruct the exact time), and granularity (the size of individual time ticks).

In some implementations, the TSN block 1202-15 (for the MIMO link 1180) provides one or more of the following parameters:
Adjacent reachable devices—ordered list of unique identifiers of immediately reachable next-hop 5G devices (list of strings);
Latency—ordered list of delay (picoseconds recommended) in transmission of smallest protocol data unit over each TSN flow to each adjacent reachable device (list of integers);
Capacity—ordered list of maximum bits per second that can be transmitted to each adjacent device (list of integers);
Frame Delay Variation (FDV)—ordered list of absolute value of the difference between the Forwarding Delay (picoseconds preferred) of two consecutive received packets belonging to the same stream to each adjacent reachable device (list of integers);
Security—ordered list of capability of the channel to evade detection (ordered list of either high or low security level); and
Reliability or Availability—ordered list of likelihoods that the channel will meet its current performance requirement (uptime) over a ratio of the expected value of the uptime of a system to the aggregate of the expected values of up and down time (ordered list of probabilities).

In some implementations, an n-dimensional array of (Latency, Capacity, FDV, Security, Reliability) values representing the MIMO-TSN block operational tradeoff space is returned from the MIMO-TSN block 1202-15 to the TSN configuration controller 1110 (e.g., from the CUC 1114 and/or the CNC 1112). The CNC 1112 may use this information to compute a schedule. The CNC 1112 may then return a single point within the n-dimensional space that the MIMO-TSN block 1202-15 uses to set its configuration (e.g., setting its channel weights as currently described in detail above).

Such an n-dimensional array may be large and add significant overhead. A number of techniques can be used to minimize this overhead. For example, instead of transferring the entire array, the CNC 1112 may be allowed to directly query the MIMO-TSN block 1202-15 for individual points within the n-dimensional space as it performs its scheduling computation. The array may be compressed/de-compressed using known data compression techniques. Sparse sampling techniques may be applied to construct a minimal array allowing interpolation of sufficient accuracy between values (e.g., lossy compression).

In accordance with aspects of the disclosure, a wireless communication system and a corresponding method are provided. The wireless communication system includes a radio network (e.g., a MIMO radio network) including a transmitter node and a receiver node. The transmitter node may be configured to determine whether a radio link associated with a plurality of subchannels is carrying time sensitive networking (TSN) traffic. In accordance with a determination that the radio link is carrying TSN traffic, the transmitter node may obtain configuration values (e.g., channel coefficient values) based on estimated quality of each of the plurality of subchannels, adjust the configuration values such that variance in quality of the plurality of subchannels is minimized, and transmit data to the receiver node via the plurality of subchannels in accordance with the adjusted configuration values. The configuration values may include a plurality of channel path coefficients, and the channel path coefficients may be represented as weights in a channel information matrix.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims.

For example, specific features of the exemplary embodiments may or may not be part of the claimed invention, different components as opposed to those specifically mentioned may perform at least some of the features described herein, and features of the disclosed embodiments may be combined.

As used herein, the terms “about” and “approximately” may refer to + or −10% of the value referenced. For example, “about 9” is understood to encompass 8.2 and 9.9.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

It will be understood that, although the terms “first,” “second,” etc. are sometimes used herein to describe various elements, these elements should not be limited by these terms. These terms are only used to distinguish one element from another.

For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

As used herein, the term “if” may be, optionally, construed to mean “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The terminology used herein is for the purpose of describing particular implementations only and is not intended to be limiting of the claims.

As used in the description of the implementations and the appended claims, the singular forms “a”, “an” and “the” are intended to include the plural forms as well, unless the context clearly indicates otherwise.

It will also be understood that the term “and/or” as used herein refers to and encompasses any and all possible combinations of one or more of the associated listed items.

It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context.

Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

1. An apparatus for wireless communication with at least one device, comprising:
at least one processor capable of communicating deterministic traffic and configured to:
obtain configuration values based on estimated quality of each of a plurality of subchannels between the apparatus and the at least one device;
adjust the configuration values such that variance in quality of the plurality of subchannels is minimized; and
transmit data to the at least one device via the plurality of subchannels in accordance with the adjusted configuration values.

2. The apparatus of claim 1, wherein the at least one device is configured to:
estimate quality of each of the plurality of subchannels by determining a signal strength perceived by each of the plurality of subchannels; and
transmit, to the apparatus, the configuration values based on the signal strength perceived by each of the plurality of subchannels.

3. The apparatus of claim 2, wherein the at least one device is configured to determine the signal strength perceived by each of the plurality of subchannels based on a pilot signal received from the apparatus via the plurality of subchannels.

4. The apparatus of claim 1, wherein:
the configuration values include a plurality of channel path coefficients;
the channel path coefficients are weighted in a channel information matrix for the plurality of subchannels; and
a higher weight is given to a subchannel having a higher estimated quality.

5. The apparatus of claim, wherein the at least one processor is configured to adjust the channel information matrix:
determining a plurality of weights for each of the plurality of channel path coefficients that would minimize variance in latency with respect to each of the plurality of subchannels; and
applying respective weights of the plurality of weights to respective channel path coefficients of the plurality of channel path coefficients.

6. The apparatus of claim 4, wherein the at least one processor is configured to adjust the channel information matrix by:
determining a plurality of weights for each of the plurality of channel path coefficients that would minimize variance in bit error rate with respect to each of the plurality of subchannels; and
applying respective weights of the plurality of weights to respective channel path coefficients of the plurality of channel path coefficients.

7. The apparatus of claim 4, wherein the at least one processor is further configured to:
maintain a history of quality estimates of each of the plurality of subchannels over time; and
adjust the plurality of channel path coefficients based on the history of quality estimates of each of the plurality of subchannels over time, wherein the estimated quality of each of the plurality of subchannels is based on a measured latency or a measured bit error rate with respect to each of the plurality of subchannels.

8. (canceled)

9. (canceled)

10. The apparatus of claim 4, wherein:
the apparatus and the at least one device are in a multiple-input multiple-output (MIMO) radio network;
the apparatus includes a plurality of antennas respectively corresponding to the plurality of subchannels;
each channel path coefficient of the plurality of channel path coefficients respectively corresponds to an antenna of the plurality of antennas;
the at least one processor is configured to:
determine whether a MIMO link associated with the plurality of subchannels is carrying time sensitive networking (TSN) traffic by determining whether data received at the MIMO link represents TSN configuration data,
in accordance with a determination that the MIMO link is carrying TSN traffic, adjust the configuration values such that variance in quality of the plurality of subchannels is minimized, and transmit the data to the at least one device via the plurality of subchannels in accordance with the adjusted configuration values; and
the TSN configuration data includes one or more of:
TSN administration cycle time,
TSN maximum latency for each flow over the MIMO link,
TSN gate control list information for each flow entering the MIMO link, or
TSN frame replication data describing member streams over the MIMO link.

11. (canceled)

12. (canceled)

13. (canceled)

14. The apparatus of claim 1, wherein adjusting the configuration values comprises at least one of:
adjusting a frequency or a time slot used to transmit the data to the at least one device; or
adjusting a modulation and coding scheme from among a plurality of modulation and coding schemes used to transmit the data to the at least one device.

15. (canceled)

16. (canceled)

17. A method performed by an apparatus, the method comprising:
obtaining configuration values based on estimated quality of each of a plurality of subchannels between the apparatus and at least one device;
adjusting the configuration values such that variance in quality of the plurality of subchannels is minimized; and
transmitting data to the at least one device via the plurality of subchannels in accordance with the adjusted configuration values.

18. The method of claim 17, wherein the at least one device is configured to:
estimate quality of each of the plurality of subchannels by determining a signal strength perceived by each of the plurality of subchannels; and
transmit, to the apparatus, the configuration values based on the signal strength perceived by each of the plurality of subchannels.

19. The method of claim 18, wherein determining the signal strength perceived by each of the plurality of subchannels is based on a pilot signal received from the apparatus via the plurality of subchannels.

20. The method of claim 17, wherein:
the configuration values include a plurality of channel path coefficients;
the channel path coefficients are weighted in a channel information matrix for the plurality of subchannels; and
a higher weight is given to a subchannel having a higher estimated quality.

21. The method of claim 20, further comprising adjusting the channel information matrix by:
determining a plurality of weights for each of the plurality of channel path coefficients that would minimize variance in latency with respect to each of the plurality of subchannels; and
applying respective weights of the plurality of weights to respective channel path coefficients of the plurality of channel path coefficients.

22. The method of claim 20, further comprising adjusting the channel information matrix by:
determining a plurality of weights for each of the plurality of channel path coefficients that would minimize variance in bit error rate with respect to each of the plurality of subchannels; and
applying respective weights of the plurality of weights to respective channel path coefficients of the plurality of channel path coefficients.

23. The method of claim 20, further comprising:
maintaining a history of quality estimates of each of the plurality of subchannels over time; and
adjusting the plurality of channel path coefficients based on the history of quality estimates of each of the plurality of subchannels over time, wherein the estimated quality of each of the plurality of subchannels is based on a measured latency or a measured bit error rate with respect to each of the plurality of subchannels.

24. (canceled)

25. (canceled)

26. The method of claim 20, wherein:
the apparatus and the at least one device are in a multiple-input multiple-output (MIMO) radio network;
the apparatus includes a plurality of antennas respectively corresponding to the plurality of subchannels;
each channel path coefficient of the plurality of channel path coefficients respectively corresponds to an antenna of the plurality of antennas;
the method further comprising:
determining whether a MIMO link associated with the plurality of subchannels is carrying time sensitive networking (TSN) traffic by determining whether data received at the MIMO link represents TSN configuration data,
in accordance with a determination that the MIMO link is carrying TSN traffic, adjusting the configuration values such that variance in quality of the plurality of subchannels is minimized, and transmitting the data to the at least one device via the plurality of subchannels in accordance with the adjusted configuration values; and
the TSN configuration data includes one or more of:
TSN administration cycle time,
TSN maximum latency for each flow over the MIMO link,
TSN gate control list information for each flow entering the MIMO link, or
TSN frame replication data describing member streams over the MIMO link.

27. (canceled)

28. (canceled)

29. (canceled)

30. The method of claim 17, wherein adjusting the configuration values comprises at least one of:
adjusting a frequency or a time slot used to transmit the data to the at least one device; or
adjusting a modulation and coding scheme from among a plurality of modulation and coding schemes used to transmit the data to the at least one device.

31. (canceled)

32. (canceled)

33. The apparatus of claim 1, wherein the variance is computed based on a linear average of signal strengths perceived by the plurality of subchannels.

34. The apparatus of claim 1, wherein:
the at least one device is configured to transmit, to the apparatus, the configuration values via a report of channel state information (CSI); and
the report of CSI is sent to the apparatus in response to a known training sequence periodically transmitted by the apparatus.

35. The method of claim 17, wherein the variance is computed based on a linear average of signal strengths perceived by the plurality of subchannels.

36. The method of claim 17, wherein:
the at least one device is configured to transmit, to the apparatus, the configuration values via a report of channel state information (CSI); and
the report of CSI is sent to the apparatus in response to a known training sequence periodically transmitted by the apparatus.

37. A device, comprising:
at least one processor capable of communicating deterministic traffic and configured to:
estimate quality of each of a plurality of subchannels between the device and an apparatus;
transmit, to the apparatus, configuration values based on the estimated quality of each of the plurality of subchannels, wherein the configuration values are adjusted by the apparatus; and
receive data from the apparatus via the plurality of subchannels in accordance with the adjusted configuration values.

38. A method performed by a device, comprising:
estimating quality of each of a plurality of subchannels between the device and an apparatus;
transmitting, to the apparatus, configuration values based on the estimated quality of each of the plurality of subchannels, wherein the configuration values are adjusted by the apparatus; and
receiving data from the apparatus via the plurality of subchannels in accordance with the adjusted configuration values.
